(19) United States
(12) Patent Application Publication
(10) Pub. No.: US 2012/0306849 A1
(43) Pub. Date: Dec. 6, 2012

(54) METHOD AND SYSTEM FOR INDICATING THE DEPTH OF A 3D CURSOR IN A VOLUME-RENDERED IMAGE

(75) Inventor: Erik N. Steen, Horten (NO)

(73) Assignee: GENERAL ELECTRIC COMPANY, Schenectady, NY (US)

(21) Appl. No.: 13/149,207

(22) Filed: May 31, 2011

(51) Int. Cl. G06T 15/00

(52) U.S. Cl. 345/419

(57) ABSTRACT

A method and system include displaying a volume-rendered image and displaying a 3D cursor in the volume-rendered image. The method and system include controlling a depth of the 3D cursor with respect to a view plane with a user interface and automatically adjusting a color of the 3D cursor based on the depth of the 3D cursor with respect to the view plane.

### FIELD OF THE INVENTION

This disclosure relates generally to a method and system for adjusting the color of a 3D cursor in a volume-rendered image in order to show the depth of the 3D cursor.

### BACKGROUND OF THE INVENTION

Volume-rendered images are very useful for illustrating 3D datasets, particularly in the field of medical imaging. Volume-rendered images are typically 2D representations of a 3D dataset. There are currently many different techniques for generating a volume-rendered image, but a commonly used technique involves using an algorithm to extract surfaces from a 3D dataset based on voxel values. Then, a representation of the surfaces is displayed on a display device. Oftentimes, the volume-rendered image will use multiple transparency levels and colors in order to show multiple surfaces at the same time, even through the surfaces may be completely or partially overlapping. In this manner, a volume-rendered image can be used to convey much more information than an image based on a 2D dataset.

When interacting with a volume-rendered image, a user will typically use a 3D cursor to navigate within the volume-rendered image. The user is able to control the position of the 3D cursor in 3 dimensions with respect to the volume-rendered image. In other words, the may adjust the position of the 3D cursor in an x-direction and a y-direction and the user may adjust the position of the 3D cursor in a depth or z-direction. It is generally easy for the user to interpret the placement of the 3D cursor in directions parallel to the view plane, but it is typically difficult or impossible for the user to interpret the placement of the 3D cursor in the depth direction (i.e. the z-direction or perpendicular to the view plane). The difficulty in determining the depth of the 3D cursor in the volume-rendered image makes it difficult to perform any tasks that require the accurate placement of the 3D cursor, such as placing markers, placing an annotation, or performing measurements within the volume-rendered image.

Therefore, for these and other reasons, an improved method of ultrasound imaging and an improved ultrasound imaging system are desired.

### BRIEF DESCRIPTION OF THE INVENTION

The above-mentioned shortcomings, disadvantages and problems are addressed herein which will be understood by reading and understanding the following specification.

In an embodiment, a method includes displaying a volume-rendered image and displaying a 3D cursor on the volume-rendered image. The method includes controlling a depth of the 3D cursor with respect to a view plane with a user interface and automatically adjusting a color of the 3D cursor based on the depth of the 3D cursor with respect to the view plane.

In another embodiment, a method includes displaying a volume-rendered image generated from a 3D dataset and positioning a 3D cursor at a first depth in the volume-rendered image. The method includes colorizing the 3D cursor a first color at the first depth. The method includes positioning the 3D cursor at a second depth in the volume-rendered image and colorizing the 3D cursor a second color at the second depth.

In another embodiment, a system for interacting with a 3D dataset includes a display device, a memory, a user input, and a processor configured to communicate with the display device, the memory and the user input. The processor is configured to access a 3D dataset from the memory and generated a volume-rendered image from the 3D dataset. The processor is configured to display the volume-rendered image on the display device. The processor is configured to display a 3D cursor on the volume-rendered image in response to commands from the user input, and the processor is configured to change the color of the 3D cursor based on the depth of the 3D cursor in the volume-rendered image.

Various other features, objects, and advantages of the invention will be made apparent to those skilled in the art from the accompanying drawings and detailed description thereof.

### BRIEF DESCRIPTION OF THE DRAWINGS

FIG. 1 is a schematic diagram of an ultrasound imaging system in accordance with an embodiment;

FIG. 2 is a schematic representation of the geometry that may be used to generate a volume-rendered image in accordance with an embodiment;

FIG. 3 is schematic representation of a volume-rendered image in accordance with an embodiment; and

FIG. 4 is a schematic representation of a user interface in accordance with an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

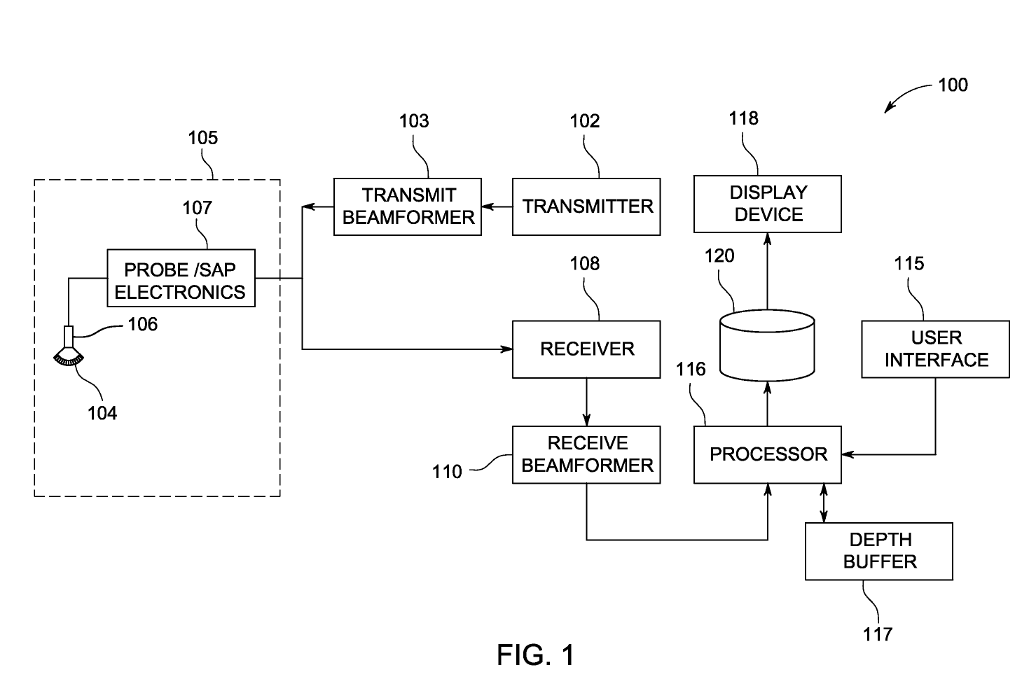

FIG. 1 is a schematic diagram of an ultrasound imaging system 100 in accordance with an embodiment. The ultrasound imaging system 100 includes a transmitter 102 that transmits a signal to a transmit beamformer 103 which in turn drives transducer elements 104 within a transducer array 106 to emit pulsed ultrasonic signals into a structure, such as a patient (not shown). A probe 105 includes the transducer array 106, the transducer elements 104 and probe/SAP electronics 107. The probe/SAP electronics 107 may be used to control the switching of the transducer elements 104. The probe/SAP electronics 107 may also be used to group the elements 104 into one or more sub-apertures. A variety of geometries of transducer arrays may be used. The pulsed ultrasonic signals are back-scattered from structures in the body, like blood cells or muscular tissue, to produce echoes that return to the transducer elements 104. The echoes are converted into electrical signals, or ultrasound data, by the transducer elements 104 and the electrical signals are received by a receiver 108. The ultrasound data may include volumetric ultrasound data acquired from a 3D region of the patient's body. The electrical signals representing the received echoes are passed through a receive beam-former 110 that outputs ultrasound data. A user interface 115 may be used to control operation of the ultrasound imaging system 100, including, to control the input of patient data, to change a scanning or display parameter, to control the position of a 3D cursor, and the like.

The ultrasound imaging system 100 also includes a processor 116 to process the ultrasound data and generate frames or images for display on a display device 118. The processor 116 may include one or more separate processing components. For example, the processor 116 may include a graphics processing unit (GPU) according to an embodiment. Having a processor that includes a GPU may advantageous for computation-intensive operations, such as volume-rendering, which will be described in more detail hereinafter. The processor 116 is in electronic communication with the probe 105 and the display device 118. The processor 116 may be hard-wired to the probe 105 and the display device 118, or the processor 116 may be in electronic communication through other techniques includes wireless communication. The display device 118 may include a screen, a monitor, a flat panel LED, a flat panel LCD, or a stereoscopic display. The stereoscopic display may be configured to display multiple images from different perspectives at either the same time or rapidly in series in order to allow the user the illusion of viewing a 3D image. The user may need to wear special glasses in order to ensure that each eye sees only one image at a time. The special glasses may include glasses where linear polarizing filters are set at different angles for each eye or rapidly-switching shuttered glasses which limit the image each eye views at a given time. In order to effectively generate a stereo image, the processor 116 may need to display the images from the different perspectives on the display device in such a way that the special glasses are able to effectively isolate the image viewed by the left eye from the image viewed by the right eye. The processor 116 may need to generate a volume-rendered image on the display device 118 including two overlapping images from different perspectives. For example, if the user is wearing special glasses with linear polarizing filters, the first image from the first perspective may be polarized in a first direction so that it passes through only the lens covering the user's right eye and the second image from the second perspective may be polarized in a second direction so that it passes through only the lens covering the user's left eye.

The processor 116 may be adapted to perform one or more processing operations according to a plurality of selectable ultrasound modalities on the ultrasound data. Other embodiments may use multiple processors to perform various processing tasks. The processor 116 may also be adapted to control the acquisition of ultrasound data with the probe 105. The ultrasound data may be processed in real-time during a scanning session as the echo signals are received. For purposes of this disclosure, the term “real-time” is defined to include a process performed with no intentional lag or delay. An embodiment may update the displayed ultrasound image at a rate of more than 20 times per second. The images may be displayed as part of a live image. For purposes of this disclosure, the term “live image” is defined to include a dynamic image that updates as additional frames of ultrasound data are acquired. For example, ultrasound data may be acquired even as images are being generated based on previously acquired data and while a live image is being displayed. Then, according to an embodiment, as additional ultrasound data are acquired, additional frames or images generated from more-recently acquired ultrasound data are sequentially displayed. Additionally or alternatively, the ultrasound data may be stored temporarily in a buffer (not shown) during a scanning session and processed in less than real-time in a live or off-line operation. Some embodiments of the invention may include multiple processors (not shown) to handle the processing tasks. For example, a first processor may be utilized to demodulate and decimate the ultrasound signal while a second processor may be used to further process the data prior to displaying an image. It should be appreciated that other embodiments may use a different arrangement of processors.

The processor 116 may be used to generate a volume-rendered image from a 3D dataset acquired by the probe 105. According to an embodiment, the 3D dataset contains a value or intensity assigned to each of the voxels, or volume elements, within the 3D dataset. In a 3D dataset acquired with an ultrasound imaging system, each of the voxels is assigned a value determined by the acoustic properties of the tissue corresponding to a particular voxel. The 3D ultrasound dataset may include b-mode data, color data, strain mode data, etc. according to various embodiments. The values of the voxels in the 3D dataset may represent different attributes in embodiments acquired with different imaging modalities. For example, the voxels in computed tomography data are typically assigned values based on x-ray attenuation and the voxels in magnetic resonance data are typically assigned values based on proton density of the material. Ultrasound, computed tomography, and magnetic resonance are just three examples of imaging systems that may be used to acquired a 3D dataset. According to additional embodiments, any other 3D dataset may be used as well.

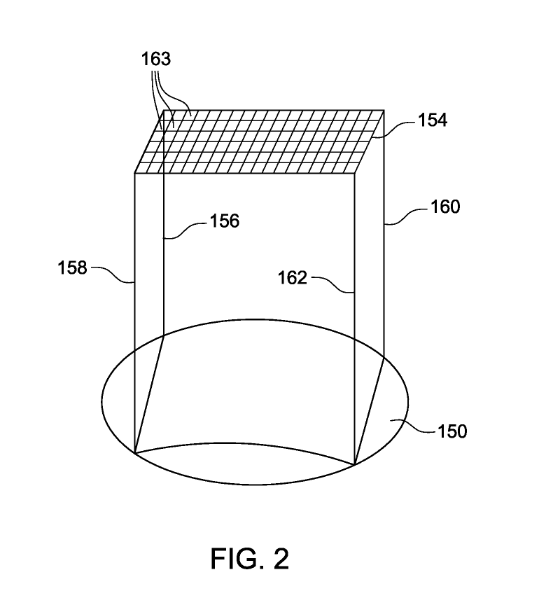

FIG. 2 is a schematic representation of the geometry that may be used to generate a volume-rendered image according to an embodiment. FIG. 2 includes a 3D dataset 150 and a view plane 154.

Referring to both FIGS. 1 and 2, the processor 116 may generate a volume-rendered image according to a number of different techniques. According to an exemplary embodiment, the processor 116 may generate a volume-rendered image through a ray-casting technique from the view plane 154. The processor 116 may cast a plurality of parallel rays from the view plane 154 to the 3D dataset 150. FIG. 2 shows ray 156, ray 158, ray 160, and ray 162 bounding the view plane 154. It should be appreciated that many more rays may be cast in order to assign values to all of the pixels 163 within the view plane 154. The 3D dataset 150 comprises voxel data, where each voxel is assigned a value or intensity. According to an embodiment, the processor 116 may use a standard “front-to-back” technique for volume composition in order to assign a value to each pixel in the view plane 154 that is intersected by the ray. Each voxel may be assigned a value and an opacity based on information in the 3D dataset. For example, starting at the front, that is the direction from which the image is viewed, each value along a ray is multiplied with a corresponding opacity. The opacity weighted values are then accumulated in a front-to-back direction along each of the rays. This process is repeated for each of the pixels 163 in the view plane 154 in order to generate a volume-rendered image. According to an embodiment, the pixel values from the view plane 154 may be displayed as the volume-rendered image. The volume-rendering algorithm may be configured to use an opacity function providing a gradual transition from opacities of zero (completely transparent) to 1.0 (completely opaque). The volume-rendering algorithm may factor the opacities of the voxels along each of the rays when assigning a value to each of the pixels 163 in the view plane 154. For example, voxels with opacities close to 1.0 will block most of the contributions from voxels further along the ray, while voxels with opacities closer to zero will allow most of the contributions from voxels further along the ray. Additionally, when visualizing a surface, a thresholding operation may be performed where the opacities of voxels are reassigned based on the values. According to an exemplary thresholding operation, the opacities of voxels with values about the threshold may be set to 1.0 while voxels with the opacities of voxels with values below the threshold may be set to zero. This type of thresholding eliminates the contributions of any voxels other than the first voxel above the threshold along the ray. Other types of thresholding schemes may also be used. For example, an opacity function may be used where voxels that are clearly above the threshold are set to 1.0 (which is opaque) and voxels that are clearly below the threshold are set to zero (translucent). However, an opacity function may be used to assign opacities other than zero and 1.0 to the voxels with values that are close to the threshold. This “transition zone” is used to reduce artifacts that may occur when using a simple binary thresholding algorithm. For example, a linear function mapping opacities to values may be used to assign opacities to voxels with values in the “transition zone”. Other types of functions that progress from zero to 1.0 may be used in accordance with other embodiments.

In an exemplary embodiment, gradient shading may be used to generate a volume-rendered image in order to present the user with a better perception of depth regarding the surfaces. For example, surfaces within the dataset 150 may be defined partly through the use of a threshold that removes data below or above a threshold value. Next, gradients may be defined at the intersection of each ray and the surface. As described previously, a ray is traced from each of the pixels 163 in the view plane 154 to the surface defined in the dataset 150. Once a gradient is calculated at each of the rays, a processor 116 (shown in FIG. 1) may compute light reflection at positions on the surface corresponding to each of the pixels and apply standard shading methods based on the gradients. According to another embodiment, the processor 116 identifies groups of connected voxels of similar intensities in order to define one or more surfaces from the 3D data. According to other embodiments, the rays may be cast from a single view point.

According to all of the non-limiting examples of generating a volume-rendered image listed hereinabove, the processor 116 may use color in order to convey depth information to the user. Still referring to FIG. 1, as part of the volume-rendering process, a depth buffer 117 may be populated by the processor 116. The depth buffer 117 contains a depth value assigned to each pixel in the volume-rendered image. The depth value represents the distance from the pixel to a surface within the volume shown in that particular pixel. A depth value may also be defined to include the distance to the first voxel that is a value above that of a threshold defining a surface. Each depth value is associated with a color value according to a depth-dependent scheme. This way, the processor 116 may generate a color-coded volume-rendered image, where each pixel in the volume-rendered image is colorized according to its depth from the view plane 154 (shown in FIG. 2). According to an exemplary colorization scheme, pixels representing surfaces at relatively shallow depths may be depicted in a first color, such as bronze, and pixels representing surfaces at deeper depths may be depicted in a second color, such as blue. The color used for the pixel may smoothly progress from bronze to blue with increasing depth according to an embodiment. It should be appreciated by those skilled in the art, that many other colorization schemes may be used in accordance with other embodiments.

Still referring to FIG. 1, the ultrasound imaging system 100 may continuously acquire ultrasound data at a frame rate of, for example, 5 Hz to 50 Hz depending on the size and spatial resolution of the ultrasound data. However, other embodiments may acquire ultrasound data at a different rate. A memory 120 is included for storing processed frames of acquired ultrasound data that are not scheduled to be displayed immediately. In an exemplary embodiment, the memory 120 is of sufficient capacity to store at least several seconds worth of frames of ultrasound data. The frames of ultrasound data are stored in a manner to facilitate retrieval thereof according to the order or time of acquisition. As described hereinabove, the ultrasound data may be retrieved during the generation and display of a live image. The memory 120 may include any known data storage medium.

Optionally, embodiments of the present invention may be implemented utilizing contrast agents. Contrast imaging generates enhanced images of anatomical structures and blood flow in a body when using ultrasound contrast agents including microbubbles. After acquiring ultrasound data while using a contrast agent, the image analysis includes separating harmonic and linear components, enhancing the harmonic component and generating an ultrasound image by utilizing the enhanced harmonic component. Separation of harmonic components from the received signals is performed using suitable filters. The use of contrast agents for ultrasound imaging is well known by those skilled in the art and will therefore not be described in further detail.

In various embodiments of the present invention, ultrasound data may be processed by other or different mode-related modules. The images are stored and timing information indicating a time at which the image was acquired in memory may be recorded with each image. The modules may include, for example, a scan conversion module to perform scan conversion operations to convert the image frames from Polar to Cartesian coordinates. A video processor module may be provided that reads the images from a memory and displays the image in real time while a procedure is being carried out on a patient. A video processor module may store the image in an image memory, from which the images are read and displayed. The ultrasound imaging system 100 shown may be a console system, a cart-based system, or a portable system, such as a hand-held or laptop-style system according to various embodiments.

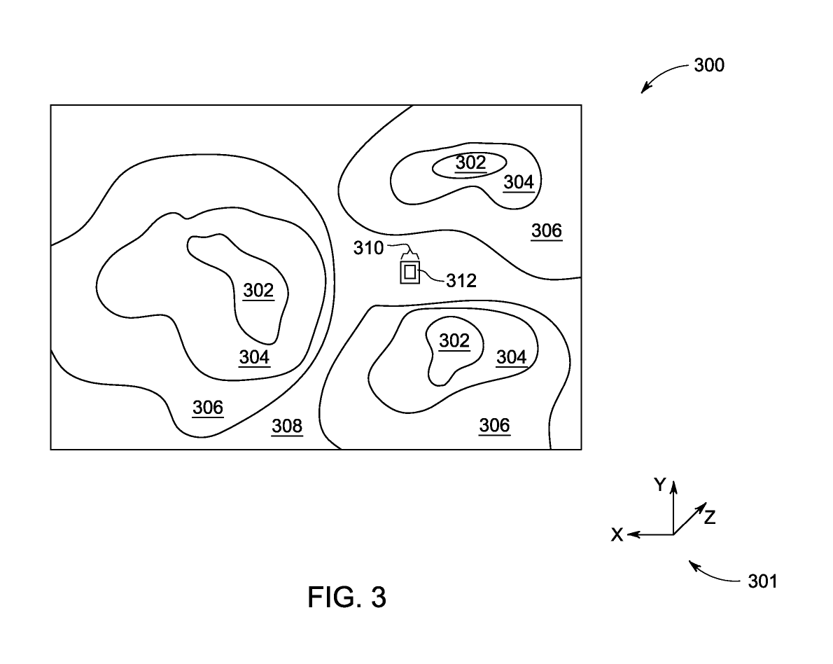

FIG. 3 is a schematic representation of a volume-rendered image 300 in accordance with an embodiment. The volume-rendered image 300 may be shown on a display device such as the display device 118 shown in FIG. 1. Volume-rendered image 300 is a simplified version of a volume-rendered image that would typically be generated from a 3D dataset. A coordinate axis 301 is shown with the volume-rendered image 300. The coordinate axis 301 shows an x-direction, a y-direction, and a z-direction. A plane may be defined by any two of the directions shown in the coordinate axis 301. For example, the view plane may be in or parallel to the x-y plane. It should be appreciated by those skilled in the art that the z-direction corresponds to depth and is perpendicular to the x-y plane.

In FIG. 3, a number of contours are shown. The contours are used as boundaries for regions of different color. As described previously, each of the colors corresponds to a depth of the surface from the view plane 154 (shown in FIG. 2). Each color may be assigned to a range of depths from the viewing plane. According with an embodiment, all the regions labeled 302 are colorized with a first color, all the regions labeled 304 are colorized with a second color, all the regions labeled 306 are colorized with a third color, and the region labeled with 308 is colorized with a fourth color. The regions of continuous color are relatively large in FIG. 2. It should be appreciated that in many other embodiment, more than four different colors may be used to show depth on the volume-rendered image. Additionally, for more complicated shapes, particularly those generated from medical imaging data, subtle variations of each color may be used to show depth to a finer resolution. For example, according to an embodiment, the gradations of color may be fine enough such that hundreds or thousands of different colors are used to give the viewer additional detail about the shape of the object at different depths.

A 3D cursor 310 is also shown. The 3D cursor is used to navigate within the volume-rendered image 300. The user may use the user interface 115 (shown in FIG. 1) to control the position of the 3D cursor 310 in directions parallel to the view plane, i.e. within the plane of FIG. 3, or the user may use the user interface 115 to control the depth or position in the z-direction of the 3D cursor 310.

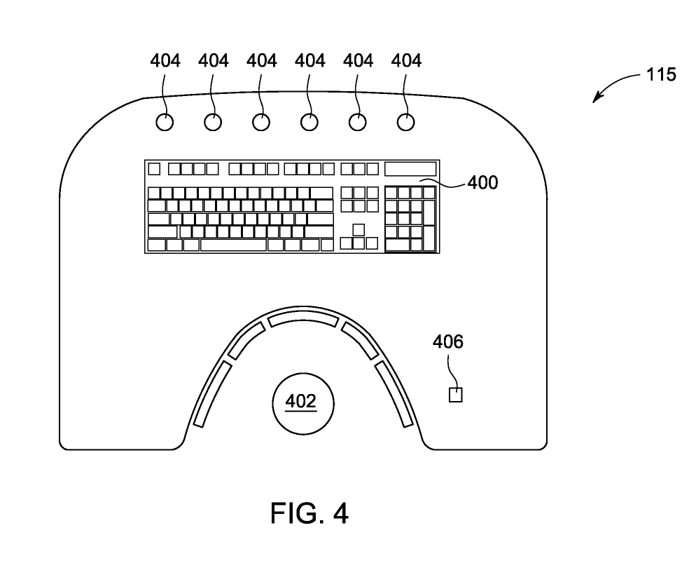

FIG. 4 is a schematic representation of the user interface 115 shown in FIG. 1 in accordance with an embodiment. In addition to other controls, the user interface 115 includes a keyboard 400, a trackball 402, a number of rotaries 404, and a button 406.

Referring now to FIGS. 3 and 4, the user may manipulate the position of the 3D cursor 310 within the image 300. The trackball 402 may be used to control the position of the 3D cursor 310. According to one embodiment, the trackball 402 may be used to position the 3D cursor 310 in a plane parallel to the x-y plane. The 3D cursor 310 may be positioned in the x-direction and the y-direction in real-time, much in the same way that a conventional cursor would be positioned on the screen of a personal computer. The user may then toggle the function of the trackball by selecting button 406. Button 406 changes the function of the trackball 406 from controlling the 3D cursor 310 in the x-y plane to controlling the position of the 3D cursor 310 in the z-direction. In other words, after selecting button 406, the user is able to easily control the depth of the 3D cursor 310 within the volume-rendered image 300. While the exemplary embodiment was described using a trackball to control the depth of the 3D cursor 310, it should be appreciated that other controls may also be used to control the position of the 3D cursor 310 including a mouse (not shown), one or more rotaries 404, a touch screen (not shown), and a gesture-tracking system (not shown).

The processor 116 (shown in FIG. 1) automatically adjusts the color of the 3D cursor 310 so that the color of the 3D cursor 310 is adjusted based on depth of the 3D cursor 310 in the volume rendered image 300. The user is able to quickly and accurately determine the depth of the 3D cursor 310 in the volume-rendered image 300 based on the color of the 3D cursor. Additionally, since the color of the 3D cursor 310 updates in real-time as the user is adjusting the depth of the 3D cursor 310, it is easy for the user to accurately navigate within the volume-rendered image 300.

As described hereinabove, the volume-rendered image 300 may be colorized according to a depth-dependent scheme, where each pixel in the volume-rendered image 300 is assigned a color based on the distance between a surface and the view plane 154 (shown in FIG. 2). According to an exemplary embodiment, the 3D cursor 310, may be colorized according to the same depth-dependent scheme used to assign colors to the pixels in the volume-rendered image 300. The user is therefore able to easily determine the depth of the 3D cursor 310 based on the color of the 3D cursor 310. According to many workflows, the user may be trying to position the 3D cursor 310 near a target structure. For example, the user may be trying to perform tasks such as adding an annotation or placing a marker at a position of interest. Or, the user may be trying to obtain a measurement between two anatomical structures. Since the depth-dependent scheme for colorizing the 3D cursor 310 is the same as that used in the volume-rendered image 300, the user may simply adjust the position of the 3D cursor 310 in the depth direction until the 3D cursor 310 is the same or approximately the same color as the target structure. The 3D cursor 310 has a fixed geometric shape of a rectangle according to an embodiment. When at the same depth as a surface in the volume-rendered image 300, it is still usually possible for the user to easily differentiate the 3D cursor 310 from the volume-rendered image because the 3D cursor 310 is rectangular in shape. Additionally, since most volume-rendered images are much more nuanced in terms of depths and hence colors than the exemplary volume-rendered image 300, most of the time the user can positively identify the 3D cursor 310 since the 3D cursor 310 is at a single depth and, therefore, a single color.

According to an embodiment, the 3D cursor 310 may include a silhouette 312 on the edge of the 3D cursor 310. The silhouette 312 may be white to additionally help the user identify the 3D cursor in the volume-rendered image 300. The user may selectively remove the silhouette 312 and/or change the color of the silhouette 312 according to other embodiments. For example, it may be more advantageous to use a dark color for the silhouette if the image is predominantly light instead of using white for the silhouette as described above in the exemplary embodiment. According to another embodiment, the processor 116 (shown in FIG. 1) may also alter the size of the 3D cursor 310 based on the depth of the 3D cursor 310 with respect to the view plane 154 (shown in FIG. 2). For example, in addition to adjusting the color of the 3D cursor 310, the processor 116 may also adjust to the size of the 3D cursor 310 with depth. According to an exemplary embodiment, the 3D cursor 310 may be shown as a larger size when the 3D cursor is close to the view plane 154 and as a smaller size when the 3D cursor 310 is further from the view plane 154. According to another embodiment, a plurality of depths in the volume-rendered image 300 may each be associated with a different 3D cursor size. Then, the user is able to additionally use the real-time size of the 3D cursor to help position the 3D cursor in the volume-rendered image 300.

According to an exemplary method, a user may position the 3D cursor 310 at a first depth. Next, the processor 116 (shown in FIG. 1) may colorize the 3D cursor 310 a first color at the first depth from the view plane 154 (shown in FIG. 2) in the volume-rendered image 300. The first color may be selected based on the first depth. For example, the processor 116 may access a lookup table that has different colors associated with various depths. Next, the user may position the 3D cursor 310 at a second depth from the view plane 154 in the volume-rendered image 300. Then, the processor 116 may colorize the 3D cursor 310 a second color at the second depth. This colorization of the 3D cursor 310 may preferably occur in real-time. The technical effect of this method is that the depth of the 3D cursor 310 within the volume-rendered image 300 is indicated by the color of the 3D cursor in real-time. The user is therefore able to use the color of the 3D cursor 310 as an indicator of the depth of the 3D cursor 310. The colors used for the 3D cursor 310 may be selected according to a depth-dependent scheme as described previously.

The 3D cursor 310 may at times be positioned by the user beneath one or more surfaces of the volume-rendered image. According to an embodiment, the processor 116 may colorize the 3D cursor 310 according to a different scheme in order to better illustrate that the 3D cursor 310 is beneath a surface. For example, the processor 116 may colorize the 3D cursor 310 with a color that is a blend between the color based solely on depth according to a depth-dependent scheme and the color of the surface that overlaps the 3D cursor 310.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A method comprising:
displaying a volume-rendered image;
displaying a 3D cursor on the volume-rendered image;
controlling a depth of the 3D cursor with respect to a view plane with a user interface; and
automatically adjusting a color of the 3D cursor based on the depth of the 3D cursor with respect to the view plane.

2. The method of claim 1, wherein the volume-rendered image is colorized according to a depth-dependent scheme.

3. The method of claim 2, wherein said automatically adjusting the color of the 3D cursor comprises adjusting the color of the 3D cursor according to the depth-dependent scheme used in the volume-rendered image.

4. The method of claim 1, further comprising positioning the 3D cursor at a position-of-interest and adding an annotation to the volume-rendered image.

5. The method of claim 1, wherein said displaying the volume-rendered image comprises displaying the volume-rendered image in a stereoscopic display.

6. The method of claim 1, wherein the user interface comprises a trackball or a rotary.

7. The method of claim 2, wherein said displaying the 3D cursor further comprises displaying a silhouette around the cursor, wherein the silhouette is shown in a different color than the cursor.

8. The method of claim 1, further comprising automatically adjusting the size of the 3D cursor based on the depth of the 3D cursor with respect to the view plane.

9. A method comprising:
displaying a volume-rendered image generated from a 3D dataset;
positioning a 3D cursor at a first depth in the volume-rendered image;
colorizing the 3D cursor a first color at the first depth;
positioning the 3D cursor at a second depth in the volume-rendered image; and
colorizing the 3D cursor a second color at the second depth.

10. The method of claim 9, wherein the volume-rendered image is colorized according to a depth-dependent scheme.

11. The method of claim 10, wherein the depth-dependent scheme comprises associating a different color with each of a plurality of depths from a view plane in the volume-rendered image.

12. The method of claim 11, wherein the first color is selected according to the depth-dependent scheme and the first depth of the 3D cursor.

13. The method of claim 12, wherein the second color is selected according to the depth-dependent scheme and the second depth of the 3D cursor.

14. The method of claim 13, wherein said displaying the volume-rendered image comprises displaying the volume-rendered image in a stereoscopic display.

15. The method of claim 9, wherein said positioning the 3D cursor at the second depth comprises positioning the 3D cursor beneath a surface of the volume-rendered image.

16. The method of claim 15, wherein the second color comprises a blend between the color of the surface and the color according to the depth-dependent scheme for the depth of the 3D cursor from the view plane.

17. A system for interacting with a 3D dataset comprising:
a display device;
a memory;
a user input; and
a processor configured to communicate with the display device, the memory and the user input, wherein the processor is configured to:
access a 3D dataset from the memory;
generate a volume-rendered image from the 3D dataset;
display the volume-rendered image on the display device;
display a 3D cursor on the volume-rendered image in response to commands from the user input; and
change the color of the 3D cursor based on the depth of the 3D cursor in the volume-rendered image.

18. The system of claim 17, wherein the display device comprises a stereoscopic display.

19. The system of claim 17, wherein the user input comprises a trackball configured to adjust the depth of the 3D cursor with respect to a view plane.

20. The system of claim 17, wherein the user input comprises a rotary.
